(19) United States
(12) Patent Application Publication
(10) Pub. No.: US 2014/0163990 A1
(43) Pub. Date: Jun. 12, 2014

(54) TENNIS UMPIRE

(71) Applicant: Christopher Street, Tarzana, CA (US)

(72) Inventor: Christopher Street, Tarzana, CA (US)

(21) Appl. No.: 14/091,783

(22) Filed: Nov. 27, 2013

Related U.S. Application Data
(60) Provisional application No. 61/797,465, filed on Dec. 7, 2012.

(51) Int. Cl. G10L 13/04; G10L 13/027

(52) U.S. Cl. CPC G10L 13/04; G10L 13/027
USPC 704/258

(57) ABSTRACT

A system for communicating game information in real time by audibly announcing game information in human speech and in a preferred embodiment also visually displaying game information, the system comprising an electronic umpire unit that receives game change information transmitted by an electronic point transmitter that may be worn by a game player or spectator.

This application claims the benefit of priority to U.S. provisional patent application 61/797,465 filed on Dec. 7, 2012, the contents of which are hereby incorporated by reference.

### BACKGROUND OF THE INVENTION

The present invention relates to an electronic system that announces the score of a game verbally during play of the game. More specifically, a preferred embodiment of the present invention is for keeping track of and verbally announcing the score during a tennis match as each point of the game is made.

In the game of tennis it has always been a problem to keep accurate score during the game. Without a score keeping system players often can disagree on the points played, forget who won the last few points, and what the current game score is. This can cause bad feelings, arguments and the delay of the game.

In casual games of tennis this problem has been addressed by a number of score keeping systems. One example would be a card system where score is tracked using a system of cards that are flipped manually to display the score. Another is the tennis ball post system where a tennis ball is inserted into an opening of a labeled vertical tennis ball holder for indicating the score. These and other similar systems all suffer from the shortcoming of having to be operated manually, which can interrupt the flow of the game, are tedious and cause delay in score keeping and/or the game itself

There are electronic scorekeeping systems which can display the score of a game, and which can be operated remotely by the players of the game. However, these systems can be difficult for players to observe from a distance unless they are quite large, powerful, and often expensive.

In tennis tournaments the problem of the players keeping track of the score is largely solved by the participation of the tennis umpire. The tennis umpire is a person who observes the game, and who verbally announces the score after every point. In this way the players of the game are aware of the score of the game without having to interrupt the game to manually set a scorekeeping system, or strain to see the score on a scorekeeping system which may be problematic in certain lighting conditions.

The present invention overcomes these problems of the prior art by providing a system that allows players in a game, such as tennis, to both easily keep track of the score and have it announced verbally after each point.

### BRIEF SUMMARY OF THE INVENTION

The system of the present invention generally comprises an electronic umpire unit that announces and displays the score of a game after each point, and an electronic point transmitter used by a player to communicate point information to the umpire unit. In a preferred embodiment involving tennis as the game the umpire unit is portable, operated from either battery power or from an alternating current source (e.g. 120 V AC outlet), and may be easily attached to the post of a tennis net. The umpire unit is also contemplated to display and announce the score on opposite facing sides of the umpire unit, such that players and observers of the game in the stands will be able to see and hear the score. The preferred embodiment is well suited to being used in a store display, preferably plugged into a main 120 V AC outlet, such that potential customers can have an opportunity to see, hear and operate the system in the store prior to purchase. The verbal announcement of game information in a retail store setting would also serve to help attract attention to the system from potential customers in the store.

In the preferred embodiment for use in a tennis game the point transmitter is worn on the wrist of at least one of the tennis players. When a point is scored the player presses a button on the point transmitter that corresponds to the side who just won the point. The transmitter then transmits the point information wirelessly to the umpire unit. The umpire unit then both updates its display of the score, and also verbally announces the score.

### BRIEF DESCRIPTION OF THE SEVERAL VIEWS OF THE DRAWINGS

FIG. 1 is a front perspective view of the umpire unit of the system.

FIG. 2 is a rear perspective view of the umpire unit of the system.

FIG. 3 is front view of the umpire unit attached to an umpire carrier unit that is attached to a tennis net post.

FIG. 4 is a front perspective view of the umpire unit attached to an umpire carrier unit that is a moveable tripod.

FIG. 5 is a front view of a point transmitter of the system that is configured to be worn on the wrist of a user.

FIG. 6 is a block diagram of the functional modules for the umpire unit of the system.

### DETAILED DESCRIPTION OF THE INVENTION

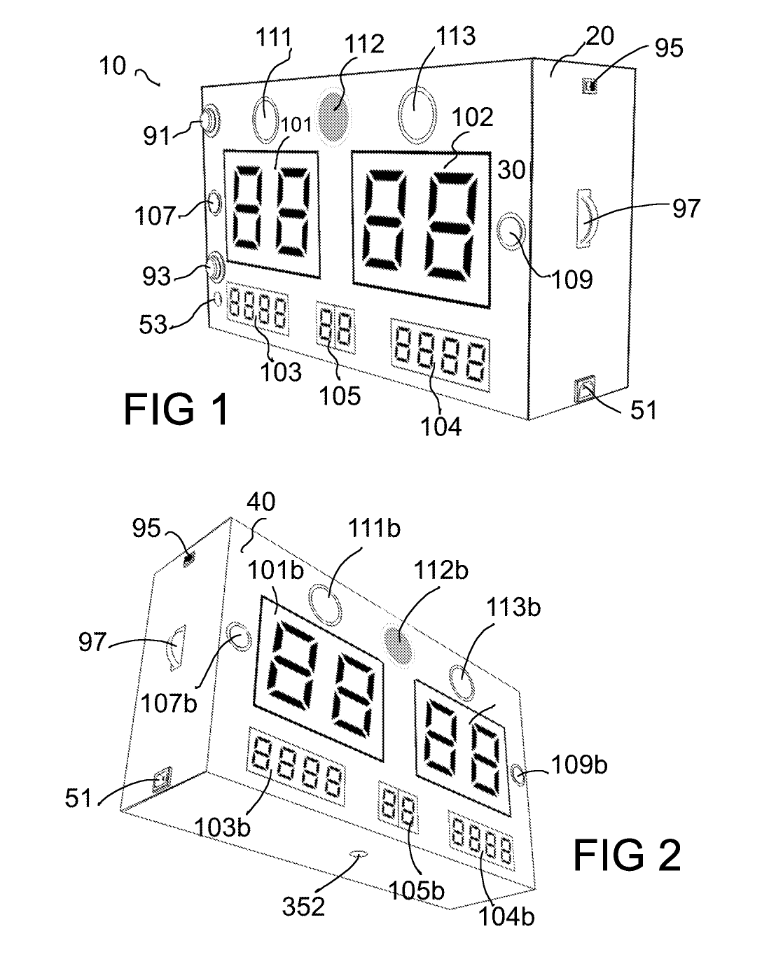

Referring to FIG. 1, in the preferred embodiment for a tennis game the umpire unit 10 has a housing 20. Housing 20 is preferably weather-proof, and of a size and shape to be portable by a single person. For example housing 20 may have one or more carrying handles (e.g. folding or collapsible such as those found on suitcases) attached to it to facilitate transportation by a person. Housing 20 may be any shape, but in a preferred embodiment housing 20 is generally rectangular in shape having a first display side 30, and referring to FIG. 2, an opposite facing second display side 40. In such an embodiment the corners and edges of housing 20 may also be rounded.

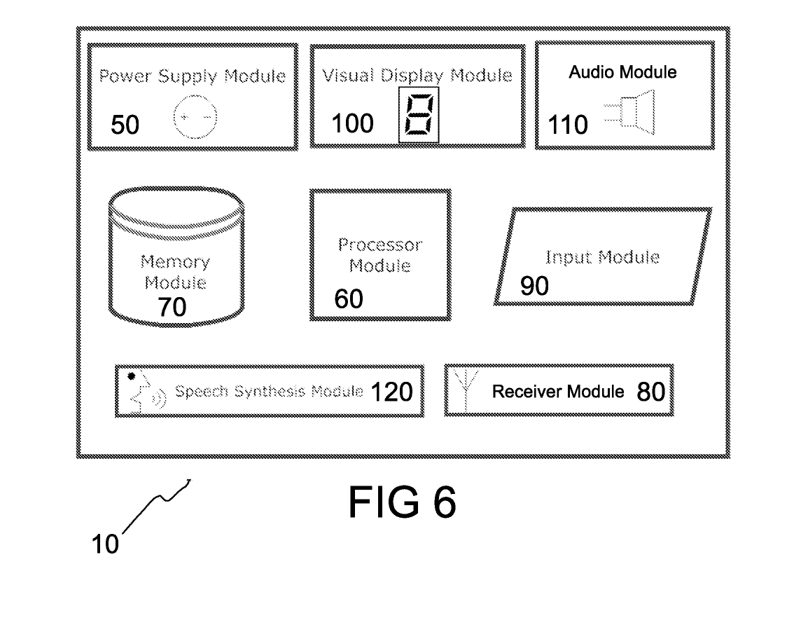

Referring to FIG. 6, Contained within housing 20 of umpire unit 10 are a number of functional modules, including a power supply module 50, a processing module 60, a memory module 70, a receiver module 80, an input module 90, a visual display module 100, an audio module 110, and a speech synthesis module 120.

Power supply module 50 provides the electrical power for the other functional modules of umpire unit 10. In a preferred embodiment power supply module 50 uses one or more rechargeable batteries to provide electrical power to the other functional module contained within umpire unit 10. Power supply module 50 is contemplated to include a battery recharging unit that may be connected to an AC power supply (e.g. a 120 volt electrical outlet) through an AC receptacle 51 in housing 20 for purposes of recharging the rechargeable batteries. It is contemplated that there may be a visual indicator (e.g. a LED) on housing 20 that indicates the current state of charge and/or charging of the rechargeable batteries. Rechargeable batteries may be either permanently installed cells, or removable and replaceable rechargeable battery cells. Any particular chemistry of rechargeable batteries may be used (e.g. nickel cadmium, nickel metal hydroxide, lithium ion, etc . . . ). Power supply module 50 may also provide power to the other functional units directly from an AC source in the event rechargeable batteries are not used or need to be replaced, and is contemplated to contain the necessary and well known circuitry to convert AC power to DC power of the appropriate voltage. It is further contemplated that Power supply module 50 may also be capable of receiving electrical direct current power through a power receptacle 53 in housing 20 that is used to connect to a 12 V direct current source, such as that from an automobile battery/cigarette lighter adapter.

Input module 90 contains input mechanisms for receiving and communicating to processing module 60 command signals and data from a user of the system. By way of example and not limitation it is contemplated in a preferred embodiment of the present invention that umpire unit 10 would have one or more input mechanisms that may be manually operated buttons, switches, or dials located on the exterior of housing 20. Referring to FIG. 1, by way of example and not limitation, there may be a reset button 91, tie breaker button 93, on/off switch 95, and volume dial 97. Such buttons, switches, or dials could be used to turn the power on or off, reset the score, or adjust the audio volume. Input mechanisms may also include a keyboard and/or touch screen built directly into umpire unit 10. It is also contemplated that input module 90 may include a computer interface mechanism, such as for example a USB connector. A computer interface mechanism may be used to connect a computing device to the umpire unit for purposes of updating or modifying operating instructions and/or data that are stored in memory module 70. The computer interface mechanism could also be used to transfer data stored in memory module 70 (e.g. related to previous games played and scores) to another system for storage, analysis, or other use.

Receiver module 80 contains the hardware for receiving point signals representing a change in game information. In a preferred embodiment the point signals are wireless radio signals and the receiver module has an antenna and associated circuitry for tuning in and receiving such signals. In a preferred embodiment of the present invention the primary function of receiver module 80 is to receive wireless radio frequency point signals from point transmitter 200 that carry change in game information, such as information on a point scored for a team. Receiver module 80 may be setup to receive such point signals on one or more RF channels, with game change information (e.g. a point scored) for a particular game team being transmitted over a particular RF channel (e.g. two RF channels for two teams). Receiver module 80 communicates any game change information to processor module 60 which processes the game change information to generate a game information update based upon the game score information received. The game information update is visually displayed and audibly announced by umpire unit 10. It is contemplated that in some embodiments receiver module 80 may establish a wireless communication link with a computing device for purposes of receiving or transmitting data to such computing device, such as for example umpire unit 10 software or database updates, diagnostic information concerning the system, or stored data regarding games played. Such a wireless communication link may be by conventional means such as Bluetooth, a conventional WiFi network, or a cellular data network.

Visual display module 100 contains the means used to visually display game update information (e.g. the current score) on umpire unit 10. In a preferred embodiment visual display module 100 is contemplated to utilize one or more visual displays, which are contemplated to incorporate seven segment displays to visually display game update information Such visual displays may be LED, LCD, or any other appropriate display means. Visual display module 100 may contain at least one seven segment display and any associated seven segment controllers necessary to interface with processing module 60 of umpire unit 10.

Referring to FIG. 1, in an exemplary embodiment of an umpire unit 10 design for tennis games, first display side 30 would have a first large visual display 101 that incorporates at least two seven segment displays for visually displaying the current points for a first tennis team, and a second large visual display 102 that incorporates at least two seven segment displays for visually displaying the current points for a second tennis team. First display side 30 would also have a first team games won visual display 103, and a second team games won visual display 104, each of which would have at least one seven segment display. There would also be a game sets won visual display 105 on first display side 30. First display side 30 would also have LED server indicators 107 and 109, and LED indicators 111 and 113 to indicate which team received the last point. It is contemplated that any visual display of game information for the different teams may be output using visual displays having different colors (e.g. red for the first team and blue for the second team).

Referring to FIG. 2, in a preferred embodiment umpire unit 10 would also output game information on a second display side 40 so that game information would be visually perceptible when viewing either the first display side 30 or second display side 40 of umpire unit 10. Thus, for example, second display side 40 would have a first large visual display 101b using at least two seven segment displays for visually displaying the current points for a first tennis team, and a second large visual display 102b using at least two seven segment displays for visually displaying the points for a second tennis team. Second display side 40 would also have a first team games won visual display 103b, and a second team games won visual display 104b, each of which would have at least one seven segment display. There would also be a game sets won visual display 105b on second display side 40. Second display side 40 would also have LED server indicators 107b and 109b, and LED indicators 111b and 113b to indicate which team received the last point.

Audio module 110 contains the means used by umpire unit 10 to verbally announce the game score using human speech. In a preferred embodiment audio module 110 is contemplated to include at least one audio speaker 112 on first display side 30, and at least one audio speaker 112b on second display side 40, for audibly announcing in human speech the score of a game. Audio module 110 is contemplated to contain any required digital-to-analog converters (DACs), and audio signal amplifiers necessary to drive the audio speakers 112 and 112b with sufficient power for the score announcement to be readily audible by a player standing at a distance of approximately one hundred feet away.

In a preferred embodiment memory module 70 is contemplated to have both non-volatile storage memory (e.g. a magnetic hard disk drive, solid state drive, flash memory etc . . . ) and volatile memory (e.g. RAM). Non-volatile memory is contemplated to store at least one operating program containing umpire unit 10 operating instructions that are accessed and executed by a microprocessor and/or controller in processing module 60 when umpire unit 10 is powered up and operating.

Processing module 60 contains at least one microprocessor or controller that is used to receive and process data (such as point signal game change information), and command and control signals to and from the other functional modules of umpire unit 10.

In the present invention umpire unit 10 contains a speech synthesis module 120 having a speech synthesizer used by umpire unit 10 to generate a human speech representation of a game information update, and to audibly announce in human speech the present score of the game through the audio speakers of audio module 110. Speech synthesis module is contemplated to retrieve speech units from a language database stored in memory module 70. The stored speech units are contemplated to include as data pre-recorded human vocalizations of points, scores and other game related information. It is contemplated that the pre-recorded human vocalizations stored and used by the system may have different selectable voice quality characteristics (e.g. pitch, timbre, tone, or register), such as for example a selection between different male and female human vocalizations. The system may use speech units having selectable voice quality characteristics to assign certain voice quality characteristics (e.g. a particular female voice) to the human speech representation for a particular team/player so as to help differentiate game information audibly communicated by the system for different teams/players. Also, if multiple systems are being used in relatively close proximity to one another (e.g. adjoining tennis courts) the different systems may use speech units having different voice quality characteristics to prevent confusion and distinguish between game information coming from the different systems. It is further contemplated that the speech units stored and used by the system may be in a plurality of different human languages (e.g. English, French, Spanish, Japanese, etc . . . ), which may be selected by a user of the system. In an alternative embodiment speech synthesis module 120 may incorporate and utilize text-to-speech synthesizer software and/or hardware which translates textual data relating to game information updates that is output by processing module 60 into human speech audio signals for output through the audio speakers of audio module 110. Such a text-to-speech synthesizer may have the ability to translate textual score data to human speech in any number of languages that may be selected by a user of the system.

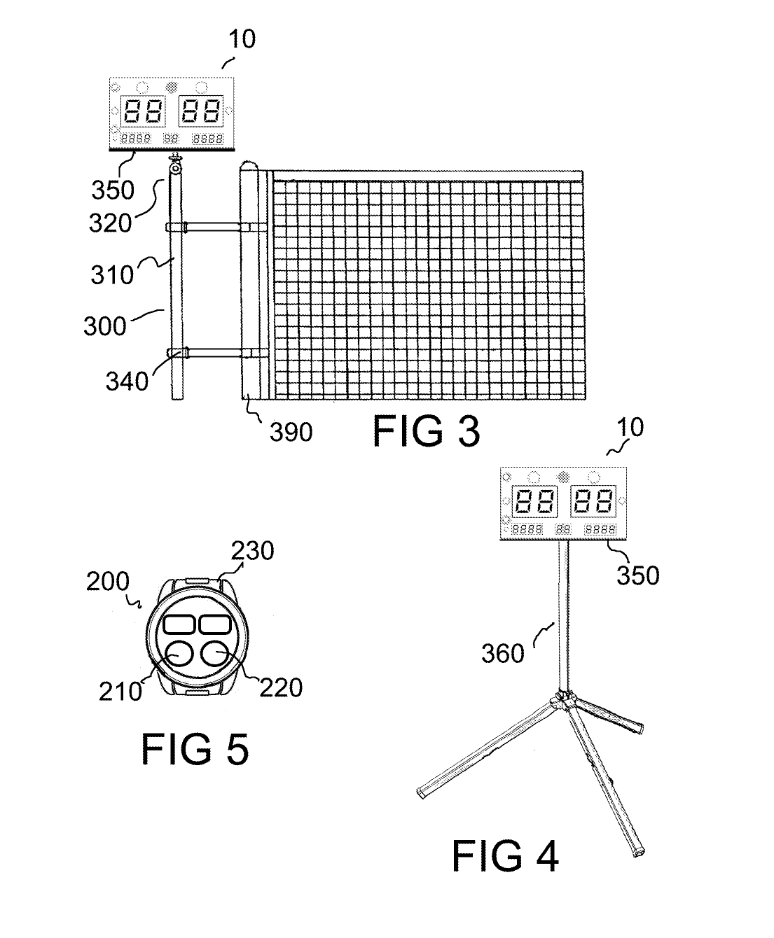

In an embodiment of the system of the present invention it is also contemplated to have an umpire unit carrier 300 for placing at a location, or attaching to an object, umpire unit 10 such that it may readily receive point signals from point transmitter 200 and still be visually and audibly perceptible to game players or spectators. Referring to FIG. 3 a preferred embodiment of the system for use in tennis games uses an umpire unit carrier 300 that has a vertical shaft 310 attached to tennis post 390 by clamping means 340. Clamping means 340 may, for example, be of a configuration like that of the bracket and tennis post gripping arrangements described and illustrated in U.S. Pat. No. 6,796,608 to Ventimiglia et al for a Tennis Teaching-Seat Assembly, the contents of U.S. Pat. No. 6,796,608 being hereby incorporated by reference as thought fully set forth herein. It is further contemplated that at a top end 320 of vertical shaft 310 would be attached an umpire platform support 350. Umpire platform support 350 may or may not be attached to vertical shaft 310 at top end 320 through an intermediate horizontal arm (not shown) that extends away at an orthogonal angle from vertical shaft 310. In such a configuration the horizontal arm would offset umpire platform support 350 to the side of vertical shaft 310. Umpire unit 10 may be attached to umpire platform support 350, such as for example by way of a thumb screw in umpire platform support 350 that mates to a female threaded screw receptacles 352 in a bottom side of umpire unit 10. Preferably umpire platform support 350 is rotatably attached to vertical shaft 310 such that umpire unit 10 may be swiveled about a vertical axis such that tennis players on both sides of the net can see the visually displayed score together with any spectators present.

Referring to FIG. 4, in an alternative embodiment umpire unit carrier 300 may be in the form of a portable tripod stand 360 with an umpire platform 350 attached to a tripod stand head 370. Preferably umpire platform support 350 is rotatably attached to tripod head 370 such that umpire unit 10 may be swiveled about a vertical axis so that players on both sides of a game can see the visually displayed score together with any spectators present. The use of a tripod stand for umpire unit carrier 300 allows more flexibility in placement of the umpire unit in relation to the game and spectators, which may be important for games other than tennis.

Referring to FIG. 5 in a preferred embodiment for a point transmitter 200 used in a game (e.g. tennis) with a first team and a second team (each team may have one or more players). In the illustrated embodiment point transmitter 200 is configured to be worn by a scorekeeper using a user attachment means, such as for example, wristband 230. The designated scorekeeper may be a participant player on one of the two teams, or alternatively may be a non-participating observer of the game.

In a preferred embodiment point transmitter 200 has a first point signal actuator 210 and a second point signal actuator 220. A point signal actuator may be any device that may be manually operated by a user to generate a point signal, such as for example a push button, a switch, or a location on a touch screen device. In the preferred embodiment first point signal actuator 210 corresponds to the first team, and second point signal actuator 220 corresponds to the second team. First point signal actuator 210 and second point signal actuator 220 are visually marked so as to distinguish them and indicate which team each point signal actuator corresponds to, with the visual marking preferably being different colors for the different point signal actuators. Thus, for example, first point signal actuator 210 may be colored red, and second point signal actuator 220 may be colored blue. It is contemplated that in the preferred embodiment point transmitter 200 would include a user attachment which is a wrist band 230 such that point transmitter 200 may be worn on the wrist of the designated scorekeeper. A user attachment however may be any means to removably attach point transmitter 200 to a user, such as for example a wrist band, a belt, a strap, a pin, etc. . . . It is further contemplated that attachment means 230 would be the same color as first point signal actuator 210, such that the designated scorer who is a player would know that he or she is always to push first point signal actuator 210 for points scored by his or her team, and the other point signal actuator for points scored by the other team. Point transmitter 200 is contemplated to be battery operated, and contain a transmitter that transmits the point signal representing a change in game information. In the preferred embodiment point transmitter 200 uses radio frequency transmitting circuitry that transmits at sufficient power such that the transmitted point signal will be received by umpire unit 10 up to a distance of two hundred feet away.

In the operation of the preferred embodiment of the present invention umpire unit 10 is attached to an umpire unit carrier 300 so that it can be readily observed and heard by participants in the game. Point transmitter 200 is worn via the attachment means by a game player or a game observer. Umpire unit 10 and point transmitter 200 are activated (i.e. the electric power of each is turned on). When a point is scored during the game, the person wearing point transmitter 200 presses a point signal actuator in the form of a button on point transmitter 200 that corresponds to the team who just won the point. Point transmitter 200 then transmits a radio frequency point signal representing the game change information. Umpire unit 10 receives the transmitted radio frequency signal with the game change information, demodulates and processes the game change information to generate a game information update. Umpire unit 10 then uses a speech synthesizer to generate a human speech representation of the game information update, which it audibly transmits over one or more audio speakers in the umpire unit. The umpire unit 10 also concurrently updates the visually displayed game information with the game information update.

While particular embodiments of the present electronic umpire system invention have been shown and described, it will be obvious to those skilled in the art that based upon the teachings herein, that changes and modifications may be made without departing from this invention and its broader aspects. For example, while the illustrated embodiments are for a system utilized in a tennis game, the present invention is not limited to use in tennis, but can be easily adapted and applied to other games such as, for example, squash, badminton, paddle tennis, racquet ball, volley ball, pickle ball, basketball etc. . . . Therefore, the appended claims are to encompass within their scope all such changes and modifications as are within the true spirit and scope of the invention.

1. An electronic umpire system for visually displaying and audibly announcing game information in real time comprising:
a point transmitter;
said point transmitter having a point signal actuator for generating a point signal representing a change in game information;
said point transmitter having a transmitter for transmitting said point signal;
an umpire unit;
said umpire unit having a receiver for receiving said transmitted point signal;
said umpire unit having a processor for producing a game information update based on said received point signal;
said umpire unit having a speech synthesizer for generating a human speech representation of said game information update;
said umpire unit having a first audio speaker for audibly transmitting said human speech representation of said game information update; and
an umpire unit carrier.

2. The electronic umpire system of claim 1 further comprising said umpire unit having a first visual display for visually displaying said game information update on a first display side of said umpire unit.

3. The electronic umpire system of claim 2 further comprising a second visual display for visually displaying said game information update on a second display side of said umpire unit.

4. The electronic umpire system of claim 3 further comprising said first audio speaker being on said first display side, and a second audio speaker on said second display side.

5. The electronic umpire system of claim 1 further comprising said point transmitter having a separate point signal actuator for each team in a game.

6. The electronic umpire system of claim 5 further comprising said point transmitter having a user attachment means.

7. The electronic umpire system of claim 6 wherein said user attachment means is a wrist band.

8. The electronic umpire system of claim 5 wherein each point signal actuator is a different color, and said user attachment has the same color as point signal actuator corresponding to the team of a user of said point transmitter.

9. The electronic umpire system of claim 1 further comprising a memory for storing a database having human speech units in at least one language.

10. The electronic umpire system of claim 9 further comprising said human speech units having at least one selectable voice quality characteristic.

11. The electronic umpire system of claim 10 wherein said human speech units are pre-recorded human vocalizations.

12. The electronic umpire system of claim 1 wherein said umpire unit carrier comprises a moveable tripod stand.

13. The electronic umpire system of claim 1 wherein said umpire unit carrier has a clamping means for attachment to a post.

14. The electronic umpire system of claim 1 wherein said umpire unit carrier has an umpire platform support that swivels about a vertical axis.

15. A method for communicating game information in real time using an electronic umpire unit and electronic point transmitter comprising the steps of:
generating a point signal representing a change in game information using a point signal actuator of said point transmitter;
transmitting said point signal with a transmitter of said point transmitter;
receiving said point signal at a receiver of said umpire unit;
generating a game information update based on said point signal with a processor of said umpire unit;
creating a human speech representation of said game information update using a speech synthesizer of said umpire unit; and
transmitting said human speech representation audibly using an audio speaker of said umpire unit.

16. The method of claim 15 for communicating game information in real time using an electronic umpire unit and electronic point transmitter further comprising the step of visually displaying said game information update on a visual display of said umpire unit.

17. The method for communicating game information in real time using an electronic umpire unit and electronic point transmitter of claim 15 further comprising the step of selecting a language of the human speech representation from a plurality of available languages.

18. The method for communicating game information in real time using an electronic umpire unit and electronic point transmitter of claim 15 further comprising the step of selecting a voice quality characteristic of the human speech representation from a plurality of available voice quality characteristics.

19. The method for communicating game information in real time using an electronic umpire unit and electronic point transmitter of claim 15 further comprising the step of attaching said umpire unit to an umpire unit carrier.

20. The method of claim 15 further comprising the step of attaching said point transmitter to a player of the game using an attachment means.
